(19) United States
(12) Patent Application Publication
(10) Pub. No.: US 2006/0233383 A1
(43) Pub. Date: Oct. 19, 2006

(54) Apparatus and method for controlling audio output of audio system

(75) Inventor: Kang-Il Lee, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/406,660

(22) Filed: Apr. 18, 2006

(30) Foreign Application Priority Data
Apr. 18, 2005 (KR) 10-2005-0032092

(51) Int. Cl. H04R 29/00

(52) U.S. Cl. 381/58

(57) ABSTRACT

An apparatus and method are disclosed for controlling an audio output of an audio system to prevent a sudden burst of an audio signal through a speaker from startling people near the audio system when an earphone is disconnected from the audio system. By muting an audio output of the audio system when the earphone is disconnected from the audio system, such a sudden burst may be avoided.

### CROSS-REFERENCE TO RELATED APPLICATIONS

Pursuant to 35 U.S.C. § 119(a), this application claims the benefit of earlier filing date and right of priority to Korean Application No. 10-2005-0032092, filed on Apr. 18, 2005, the contents of which is hereby incorporated by reference herein in its entirety.

### BACKGROUND OF THE INVENTION

1. Field of the Invention

The present invention relates to an audio system and, more particularly, to an apparatus and method for controlling an audio output of an audio system.

2. Description of the Related Art

In general, an audio system for an MP3 player (MPEG layer 3 player), a cassette player, a mobile communication terminal or a PDA (Personal Digital Assistant) includes a speaker and an earphone terminal (earphone jack). When the earphone is disconnected from the audio system, an audio signal is automatically output through the speaker installed in the audio system and when the earphone is connected to the audio system the audio signal is automatically output through the earphone.

However, the related art audio system has a problem when the earphone is unintentionally disconnected from the audio system while a user is listening to music through the earphone. If this happens, the audio signal (sound) is automatically output through the speaker, thereby startling people near the speaker and embarrassing the user.

Therefore, there is a need for an apparatus and method for controlling an audio output of an audio system that prevents a sudden burst of an audio signal from a speaker when an earphone is disconnected from the audio system. The present invention addresses these and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The invention is directed to provide an apparatus and method for controlling an audio output of an audio system that prevents a sudden burst of an audio signal from a speaker when an earphone is disconnected from the audio system. One object of the present invention is to provide an apparatus and method for controlling an audio output of an audio system that mutes an audio output of the audio system when an earphone is disconnected from the audio system. Another object of the present invention is to provide an apparatus and method for controlling an audio output of an audio system that informs a user that an earphone has been disconnected from the audio system.

In one aspect of the present invention, a method for controlling an audio output of a portable audio device having at least one speaker integrated therein is provided. The method includes detecting that an external listening device has been disconnected from the portable audio device and altering the audio output such that no sudden burst of an audio signal is generated from the at least one speaker.

It is contemplated that the method further includes displaying a message indicating that the external listening device has been disconnected. It is further contemplated that the method further includes no longer altering the audio output when a specific response to the message is received.

It is contemplated that the method further includes outputting the audio signal to one of the external listening device and the at least one speaker according to the specific response. It is further contemplated that the method further includes not altering the audio output when the external listening device is connected to the portable audio device.

It is contemplated that the method further includes displaying a message indicating that the external listening device has been connected. It is further contemplated that the message is a message requesting whether to output the audio signal to the at least one speaker.

It is contemplated that the external listening device is an earplug. It is further contemplated that altering the audio output comprises muting the audio output.

In another aspect of the present invention, a method for controlling an audio output of a portable audio device is provided. The method includes detecting that an earphone has been disconnected from the portable audio device, muting the audio output and displaying a message indicating that the earphone has been disconnected.

It is contemplated that the method further includes no longer muting the audio output when a specific response to the message is received and outputting an audio signal to one of the earplug and at least one speaker integrated into the portable audio device according to the specific response. It is further contemplated that the method further includes no longer muting the audio output and outputting an audio signal to the earplug when the earplug is connected to the portable audio device and displaying a message indicating that the earplug has been connected.

In another aspect of the present invention, an apparatus for controlling an audio output of a portable audio device having at least one speaker integrated therein is provided. The apparatus includes a detecting unit adapted to generate a disconnection signal when an external listening device is disconnected from the portable audio device and a controller adapted to alter the audio output according to the disconnection signal such that no sudden burst of an audio signal is generated from the at least one speaker.

It is contemplated that the apparatus further includes a display unit and the controller is further adapted to generate and display a message on the display unit, the message indicating that the external listening device has been disconnected. It is further contemplated that the message is an acknowledgement message that inquires if the user desires to output the audio signal to the at least one speaker.

It is contemplated that the controller is further adapted to no longer alter the audio output when a specific response to the message is received. It is further contemplated that the controller is further adapted to output an audio signal to one of the external listening device and the at least one speaker when the specific response is received.

In another aspect of the present invention, an apparatus for controlling an audio output of a portable audio device is provided. The apparatus includes an earphone jack adapted to receive an earphone, one or more speakers adapted to reproduce an audio signal, a detecting unit adapted to generate a disconnection signal if the earphone is disconnected from the earphone jack and a controller adapted to mute the audio output according to the disconnection signal, generate and display a message indicating that the earphone has been disconnected and output an audio signal to one of the earphone jack and the speakers according to a specific response to the message received from a user.

It is contemplated that the apparatus further includes a converting unit adapted to convert a digital audio signal into an analog audio signal and a switch adapted to output the analog audio signal to the earphone jack according to a first control signal and output the analog audio signal to the at least one speaker according to a second control signal, wherein the detecting unit is further adapted to generate a connection signal when the earphone is connected to the earphone jack and the controller is further adapted to generate the digital audio signal according to the connection signal and to generate the first control signal and second control signal according to the specific response. Preferably, the controller is further adapted to generate the first control signal when the specific response selects the earphone jack and to generate the second control signal when the specific response selects the at least one speaker. It is further contemplated that the apparatus further includes a display unit having a touch pad on a screen adapted to allow the user to enter the specific response.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed. These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is an exemplary view illustrating the construction of a triode earphone plug and a tetrode earphone plug.

FIG. 2 is a block diagram illustrating the construction of an apparatus for controlling an audio output of an audio system in accordance with the present invention.

FIG. 3 is a flow chart illustrating a method for controlling an audio output of an audio system in accordance with the present invention.

### DETAILED DESCRIPTION OF THE PREFERRED EMBODIMENTS

The present invention relates to an apparatus and method for controlling an audio output of an audio system that mutes an audio output of the audio system when an earphone is disconnected from the audio system, thereby preventing a sudden burst of an audio signal from a speaker. It is contemplated that the present invention may be utilized anytime it is desired to prevent a sudden burst of an audio signal from a speaker when an earphone is disconnected from an audio system.

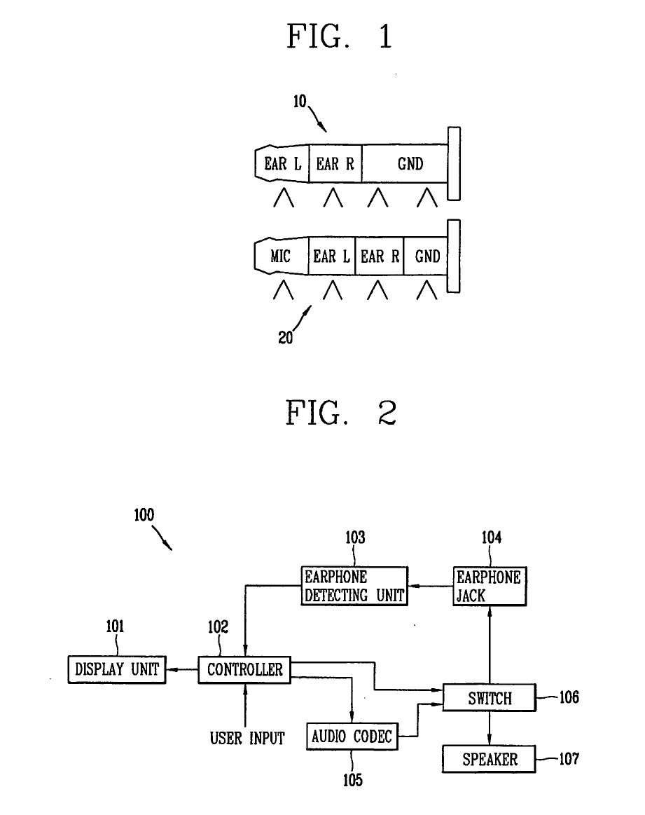

Reference will now be made in detail to the preferred embodiments of the present invention, examples of which are illustrated in the accompanying drawings. An apparatus and method in accordance with the present invention for controlling an audio output of an audio system such that a sudden burst of an audio signal from a speaker is prevented by muting an audio output of the audio system when an earphone is disconnected from the audio system will be described with reference to FIGS. 1 to 3.

FIG. 1 is an exemplary view showing the construction of a triode earphone plug 10 and a tetrode earphone plug 20. As illustrated in FIG. 1, the triode earphone plug 10 includes a left audio terminal (EAR L), a right audio terminal (EAR R) and a ground terminal (GND), while the tetrode earphone plug 20 includes a left audio terminal (EAR L), a right audio terminal (EAR R), a ground terminal (GND) and an external input terminal (MIC).

An earphone detecting unit detects whether an earphone plug is connected to the audio system, for example via an earphone jack. When the earphone plug is disconnected from the audio system, the audio system automatically mutes an audio signal.

Additionally, after the audio system automatically mutes the audio signal, the audio signal is output through a speaker according to a user request. Furthermore, if the earphone plug is re-connected to the audio system after the audio system automatically muted the audio signal, the audio system automatically outputs the audio signal through the earphone. Therefore, when the earphone plug is disconnected from the audio system, the audio output (audio signal) of the audio system is muted to prevent the audio signal from suddenly being output through a speaker and thereby preventing a sudden burst of an audio signal from startling people near the audio system.

As illustrated in FIG. 2, the apparatus 100 for controlling the audio output of an audio system in accordance with the present invention includes an earphone detecting unit 103 for generating a disconnection detect signal when the earphone plug (not shown) is disconnected from an earphone jack 104 of the audio system. The apparatus 100 further includes a controller 102 for generating an audio signal and muting the audio signal (audio output) when the disconnection detect signal is received.

The controller 102 can generate a message informing that the earphone plug has been disconnected based on the disconnection detect signal and transmit the generated message to a display unit 101. The display unit 101 displays the message on its screen.

When the earphone plug is connected with the earphone jack 104, the earphone detecting unit 103 generates a connection detect signal and outputs the signal to the controller 102. The earphone detecting unit 103 can detect whether the earphone plug has been connected with the earphone jack 104 by detecting a signal, for example a Vcc signal, a GND signal or a sound signal output through an earphone detection terminal (not shown) installed within the earphone jack 104. It is contemplated that various methods may be used to detect that the earphone plug has been connected with the earphone jack 104.

The controller 102 generates a digital audio signal according to a connection detect signal or a user request and outputs the generated digital audio signal to an audio codec 105. Furthermore, the controller 102 generates a first control signal for selecting the earphone jack 104 based on the connection detect signal and outputs the first control signal to a switch 106.

The audio codec 105 converts the digital audio signal into an analog audio signal and outputs the analog signal to the switch 106. The switch 106 is connected to the earphone jack 104 and a speaker 107 and outputs the analog audio signal to the earphone plug through the earphone jack 104 according to the first control signal of the controller 102.

When the earphone plug is disconnected from the earphone jack 104, the earphone detecting unit 103 generates a disconnection detect signal and outputs the signal to the controller 102. The controller 102 then mutes the digital audio signal based on the disconnection detect signal, generates a message indicating that the earphone plug has been disconnected based on the disconnection detect signal and outputs the message to the display unit 101.

The display unit 101 displays the message on its screen. When a response to the message, for example, a signal for selecting the speaker 107 or a signal for selecting the earphone is received from the user, the controller 102 no longer mutes the digital audio signal and outputs the digital audio signal to the audio codec 105. An LCD (Liquid Crystal Display) or an LED (Light Emitting Diode) can be used as the display unit 101.

Thereafter, when a response to the message, for example, a signal for selecting the speaker 107, is received from the user, the controller 102 generates a second control signal for selecting the speaker and outputs the second control signal to the switch 106. For example, when the user selects a specific item, for example, the speaker 107, in response to the message using a touch pad (not shown) installed on a screen of the display 101, the controller 102 outputs the second control signal to the switch 106.

When the connection detect signal is received from the earphone detecting unit 103 while the message is being displayed, the controller 102 generates the first control signal and outputs it to the switch 106. The switch 106 outputs the analog audio signal from the audio codec 105 to the earphone jack 104 or the speaker 107 according to the first or second control signal.

The message indicates whether to output the audio signal to the speaker 107 of the audio system and further indicates selection of the earphone or the speaker. For example, when the speaker 107 is selected by the user, the controller 102 outputs the audio signal through the speaker and when the earphone is selected, the controller 102 assumes that the earphone has been connected again to the earphone jack and outputs the audio signal through the earphone.

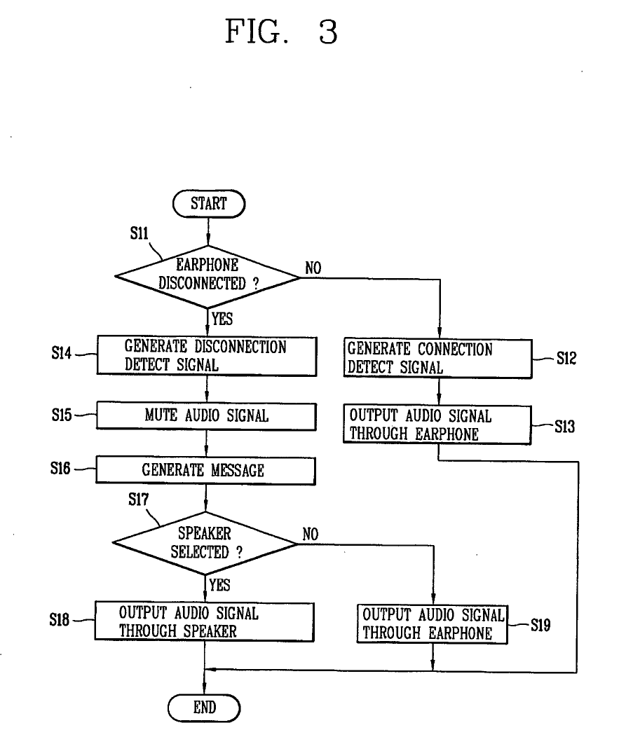

FIG. 3 is a flow chart illustrating a method for controlling an audio output of the audio system in accordance with the present invention. As illustrated in FIG. 3, the earphone detecting unit 103 checks whether the earphone has been disconnected from the earphone jack 104 (step S11). For example, when the earphone is connected with the earphone jack 104, the earphone detecting unit 103 generates the connection detect signal (step S12) and outputs the signal to the controller 102.

The controller 102 generates the digital audio signal according to the connection detect signal, and outputs the generated digital audio signal to the audio codec 105. Furthermore, the controller generates the first control signal for selecting the earphone jack 104 based on the connection detect signal and outputs the first control signal to the switch 106.

The audio codec 105 converts the digital audio signal into the analog audio signal and outputs the analog audio signal to the switch 106. The switch 106 is connected with the earphone jack 104 and the speaker 107 and outputs the analog audio signal to the earphone through the earphone jack 104 according to the first control signal (step S13).

When the earphone is disconnected from the earphone jack 104, the earphone detecting unit 103 generates the disconnection detect signal (step S14) and outputs the disconnection detect signal to the controller 102. The controller 102 mutes the digital audio signal based on the disconnection detect signal (step S15), generates the message indicating that the earphone has been disconnected (step S16) and outputs the message to the display unit 101. For example, the controller generates an acknowledgement message such as ‘want to output audio signal through speaker?’ and at the same time mutes the digital audio signal.

The display unit 101 displays the message, such as the acknowledgement message, on its screen. If a response to the message is received from the user that is a signal for selecting the speaker 107 (step S17), the controller 102 no longer mutes the digital audio signal output to the audio codec 105. When the signal for selecting the speaker 107 is received from the user, the controller 102 generates the second control signal for selecting the speaker 107 and outputs the second control signal to the switch 106.

For example, when the user selects a specific item, such as the speaker 107, in response to the message via the touch pad (not shown) installed on the screen of the display 101, the controller 102 outputs the second control signal to the switch 106. The switch 106 outputs the analog audio signal to the speaker 107 based on the second control signal (step S18).

When the user selects the earphone in response to the message via the touch pad installed on the screen of the display 101 (step S17), the controller 102 outputs the first control signal to the switch 106. Furthermore, when the connection detect signal is received from the earphone detecting unit 103 while the message is being output, the controller 102 generates the first control signal and outputs it to the switch 106. The switch 106 outputs the analog audio signal to the earphone jack 104 based on the first control signal (step S19).

Accordingly, when the earphone is disconnected from the audio system, such as by a mistake of the user, the audio output (audio signal) of the audio system is muted to prevent the audio signal from suddenly being output through a speaker and thereby preventing a sudden burst of an audio signal from startling people near the audio system. The apparatus and method for controlling the audio output of the audio system in accordance with the present invention can be applied to various devices using an audio system, such as a PDA (Personal Digital Assistant).

As described herein, the apparatus and method for controlling the audio output of the audio system in accordance with the present invention have advantages. For example, when the earphone is disconnected from the audio system, the audio output of the audio system can be muted to prevent a sudden burst of the audio signal through the speaker from startling people near the audio system. Furthermore, the user can be informed of the earphone disconnection by displaying a message on the display unit of the audio system.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present invention may be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for controlling an audio output of a portable audio device having at least one speaker integrated therein, the method comprising:
detecting that an external listening device has been disconnected from the portable audio device; and
altering the audio output such that no audio signal is generated from the at least one speaker.

2. The method of claim 1, further comprising displaying a message indicating that the external listening device has been disconnected.

3. The method of claim 2, further comprising no longer altering the audio output when a specific response to the message is received.

4. The method of claim 3, further comprising outputting the audio signal to one of the external listening device and the at least one speaker according to the specific response.

5. The method of claim 1, further comprising not altering the audio output when the external listening device is connected to the portable audio device.

6. The method of claim 1, further comprising displaying a message indicating that the external listening device has been connected.

7. The method of claim 2, wherein the message is a message requesting whether to output the audio signal to the at least one speaker.

8. The method of claim 1, wherein the external listening device is an earplug.

9. The method of claim 1, wherein altering the audio output comprises muting the audio output.

10. A method for controlling an audio output of a portable audio device, the method comprising:
detecting that an earphone has been disconnected from the portable audio device;
muting the audio output; and
displaying a message indicating that the earphone has been disconnected.

11. The method of claim 10, further comprising:
no longer muting the audio output when a specific response to the message is received; and
outputting an audio signal to one of the earplug and at least one speaker integrated into the portable audio device according to the specific response.

12. The method of claim 10, further comprising:
no longer muting the audio output and outputting an audio signal to the earplug when the earplug is connected to the portable audio device; and
displaying a message indicating that the earplug has been connected.

13. An apparatus for controlling an audio output of a portable audio device having at least one speaker integrated therein, the apparatus comprising:
a detecting unit adapted to generate a disconnection signal when an external listening device is disconnected from the portable audio device; and
a controller adapted to alter the audio output according to the disconnection signal such that no audio signal is generated from the at least one speaker.

14. The apparatus of claim 13, further comprising a display unit and wherein the controller is further adapted to generate and display a message on the display unit, the message indicating that the external listening device has been disconnected.

15. The apparatus of claim 14, wherein the message is an acknowledgement message that inquires if the user desires to output the audio signal to the at least one speaker.

16. The apparatus of claim 14, wherein the controller is further adapted to no longer alter the audio output when a specific response to the message is received.

17. The apparatus of claim 16, wherein the controller is further adapted to output an audio signal to one of the external listening device and the at least one speaker when the specific response is received.

18. An apparatus for controlling an audio output of a portable audio device, the apparatus comprising:
an earphone jack adapted to receive an earphone;
at least one speaker adapted to reproduce an audio signal;
a detecting unit adapted to generate a disconnection signal if the earphone is disconnected from the earphone jack; and
a controller adapted to mute the audio output according to the disconnection signal, generate and display a message indicating that the earphone has been disconnected and output an audio signal to one of the earphone jack and the at least one speaker according to a specific response to the message received from a user.

19. The apparatus of claim 18, further comprising:
a converting unit adapted to convert a digital audio signal into an analog audio signal; and
a switch adapted to output the analog audio signal to the earphone jack according to a first control signal and output the analog audio signal to the at least one speaker according to a second control signal,
wherein the detecting unit is further adapted to generate a connection signal when the earphone is connected to the earphone jack and the controller is further adapted to generate the digital audio signal according to the connection signal and to generate the first control signal and second control signal according to the specific response.

20. The apparatus of claim 19, wherein the controller is further adapted to generate the first control signal when the specific response selects the earphone jack and to generate the second control signal when the specific response selects the at least one speaker.

21. The apparatus of claim 18, further comprising a display unit having a touch pad on a screen adapted to allow the user to enter the specific response.
